(19) United States
(12) Patent Application Publication
(10) Pub. No.: US 2024/0322506 A1
(43) Pub. Date: Sep. 26, 2024

(54) SINGLE-PAIR ETHERNET SWITCHING APPARATUS

(71) Applicant: HARTING ELECTRONICS GMBH, Espelkamp (DE)

(72) Inventors: Markus FRIESEN, Espelkamp (DE); Felix LOSKE, Minden (DE)

(21) Appl. No.: 18/271,644

(22) PCT Filed: Feb. 14, 2022
(86) PCT No.: PCT/DE2022/100123

§ 371 Date: Jul. 10, 2023

(30) Foreign Application Priority Data
Feb. 22, 2021 (DE) 10 2021 104 130.9

(51) Int. Cl. H01R 24/64; H01R 4/2433

(52) U.S. Cl. CPC H01R 24/64; H01R 4/2433; H01R 2201/04

(57) ABSTRACT

A switching apparatus for providing a single-pair Ethernet (SPE/T1-Ethernet) connection, has a first interface (I1) and second interface (I2), wherein the first interface is a multi-pole and in particular a MIL or RMII interface, and the second interface is a dual-pole SPE/T1-specific interface. The switching apparatus furthermore has first electronics suitable for 100Base-T1 operation and/or second electronics suitable for 10Base-T1L operation and/or third electronics suitable for 10Base-T1S operation of the second interface. Also disclosed is an Ethernet switch and to an SPE/T1 development board that each have an above switching apparatus.

The invention relates to a network switching apparatus and in particular to a single pair Ethernet switching apparatus suitable for many applications and in particular to a single pair Ethernet switch.

Such switching apparatuses and switches are needed to connect devices in a network to enable data communication between different network devices.

IEEE 802.3bw is an IEEE standard for Ethernet data transmission over single pair copper cables with twisted pairs at 100 megabits per second. The standard specifies the 100Base-T1 Ethernet interface, which enables data transmission at a speed of 100 megabits per second to 1 GBit per second over single pair copper cables with twisted pairs, wherein only one copper pair, therefore single pair Ethernet (SPE/T1 Ethernet), is required for data transmission.

At the same time, SPE/T1 Ethernet enables the power supply of end devices via data line (via Power over Data Line) (PoDL). Single pair Ethernet transmission with transmission ranges of up to 1000 meters is particularly suitable for use in process automation and in industrial automation. Single pair cabling is also fast, space-saving, cost-effective and easy to implement.

In addition, with the growth of the Internet of Things (IoT) and industrial and automotive applications in particular, SPE/T1 Ethernet has emerged as a promising technology given the growing need for low-cost power supply, data connectivity and security for the large number of end devices that will be deployed in the future.

The SPE/T1 Ethernet provides for the non-compatible standards T1, T1L and T1S to cover the above application range. T1 is particularly suitable for the use in automotive Ethernet and allows a data transmission of 100 MBit/s to 1000 MBit/s with a maximum range of 15 m (shielded up to 40 m). T1L, with a data transmission rate of 10 Mbit/s and a range of 1000 m (up to 1700 m possible), is intended for the long range, and T1S, with a range of 15 m and a data transmission rate of 10 Mbit/s, permits multi-drop operation of up to eight subscribers in the short range.

### PRIOR ART

Document US 2020/0153174 A1 described a connection system comprising a plug connector and a connector socket, which system is intended to be suitable for the provision of a single pair Ethernet connection of a variety of different devices. For this purpose, the plug connector has a common interface with the same external dimensions and the same contact/pin spacing for cables of different thicknesses that support single pair Ethernet.

However, the above T1, T1L and T1S standards are electrically incompatible with each other, and therefore the use and operation of their equipment and devices and their networking is accordingly limited to one of the stated standards, and therefore the connection system known from US 2020/0153174 A1 is likewise disadvantageously limited to the provision of a connection of correspondingly compatible equipment and devices.

The T1, T1L and T1S standards differ here in their physical layer and data link layer of the OSI model, and therefore each standard requires its own electrical interface for data transmission. Unlike the physical layer and data link layer, the T1, T1L and T1S standards are compatible with each other in the other layers of the OSI model, such as the network IP layer or the application layer.

The German Patent and Trade Mark Office has searched the following prior art in the priority application for the present application: DE 10 2019 126 341 A1, DE 10 2021 105 867 A1, DE 10 2015 211 107 A1, US 2019/0104085 A1, U.S. Pat. No. 10,708,630 B1, Marvell® Brightlane™ 88Q2110/88Q2112 100/1000BASE-T1 PHY Product Brief, and Marvell® Brightlane™ 88Q1010 100BASE-T1 PHY Product Brief.

### Problem

The problem addressed by the invention is that if providing a switching apparatus for providing a single pair Ethernet (SPE/T1-Ethernet) connection that is intended to be suitable for a variety of devices and applications. In particular, it is an object of the invention to provide an SPE/T1 Ethernet switch.

The object is achieved by the characterizing features of independent claim 1.

Advantageous embodiments of the invention are described in the dependent claims and/or the following description.

In particular, the invention relates to a switching apparatus for providing a single pair Ethernet (SPE/T1-Ethernet) connection, having a first and second interface. The first interface is suitably a multi-pole and in particular an MII or RMII interface, and the second interface is advantageously a two-pole SPE/T1-Ethernet specific interface. In this case, the switching apparatus is set up in such a way that a data transmission can be switched from the first to the second interface and from the second to the first interface.

For an operation of the second interface, the switching apparatus suitably comprises first electronics suitable for a 100Base-T1 operation and/or second electronics suitable for a 10Base-T1L operation and/or third electronics suitable for a 10Base-T1S operation. By means of the above first T1 electronics and/or the second T1L electronics and/or the third T1S electronics, a selected SPE/T1 specific operation of the second interface can be selected and switched.

The first T1 electronics can be suitably provided by means of a 100Base T1 Ethernet PHY-IC with further passive components.

The second T1L electronics can be suitably provided by means of a 10Base T1L Ethernet PHY-IC with additional passive components.

The third T1S electronics can be suitably provided by means of a 10Base T1S Ethernet PHY-IC with additional passive components.

The aforementioned first T1 electronics and the second T1L electronics and the third T1S electronics can be suitably designed and set up such that a data transmission can be switched from the first interface to the second interface and from the second interface to the first interface.

By means of the aforementioned switching apparatus, the non-compatible SPE/T1 Ethernet standards T1, T1L and T1S can be advantageously switched between the first and second interfaces, wherein in particular the second interface of the switching apparatus is suitable for switching a suitable compatible operation.

The switching apparatus can suitably have at least one printed circuit board with the first T1 or second T1L or third T1S electronics. The printed circuit board provided with the first T1 or second T1L or third T1S electronics can be designed in such a way that the printed circuit board can be plugged onto a slot of a printed circuit board of a first device in such a way that the first interface of the switching apparatus is connected to electronics of the printed circuit board of the first device.

The printed circuit board provided with the first T1 or second T1L or third T1S electronics can be advantageously designed here in such a way that the printed circuit board can be plugged into a slot on the printed circuit board of the first device in such a way that the second interface is connected to a socket part of a plug connector provided on the printed circuit board of the first device. The socket part is suitably arranged here on the printed circuit board of the first device and is provided for a plug connection with a plug part of the plug connector, which is connected to a two-core single pair Ethernet cable. For this purpose, the socket part has a suitable second interface.

By means of a selection of a suitable compatible printed circuit board, which may comprise a first T1 electronics, a second T1L electronics or a third T1S electronics, a predetermined compatible T1 operation, T1L operation or T1S operation of the second interface for the socket part can be provided in a simple manner. In this way, an operation of the switching apparatus, and, in particular, of the second interface of the socket part, that is compatible with a second device connected to the socket part of the first device via the plug part can be switched.

The aforementioned switching apparatus may have at least one plug connector with the first T1 or second T1L or third T1S electronics and with the first and second interfaces in place of the printed circuit board provided with the first T1 or second T1L or third T1S electronics.

The plug connector can suitably be a socket part, which is connected by its first interface to the printed circuit board of the first device. The socket part can advantageously be provided via its second interface for a plug connection to a plug part that is connected to a two-core single pair Ethernet cable.

In this way, as in the above embodiment of the switching apparatus, an operation of the switching apparatus, and, in particular, of the second interface, that is compatible with a second device connected to the socket part of the first device via the plug part can be switched. By means of a selection of a suitable compatible socket part, which may comprise first T1 electronics or second T1L electronics or third T1S electronics compatible with the plug part and the second device, a predetermined compatible T1 operation, T1L operation or T1S operation of the second interface of the socket part with the plug part, the cable and a T1 operation, T1L operation or T1S operation of the second device may be provided in a simple way.

The protruding plug connector can also be a plug part instead of the socket part and can have first T1 electronics or second T1L electronics or third T1S electronics compatible with a second device. The plug part can be suitably provided here with its first interface for a plug connection to a socket part of the printed circuit board of the first device, and with its second interface can be connected to a two-core single pair Ethernet cable.

According to another particularly advantageous embodiment of the invention, the switching apparatus may comprise the first T1 electronics and the second T1L electronics and the third T1S electronics and additionally first 11 and second 12 switching units.

The first and second switching units can advantageously be designed and set up here in such a way that in each case a connection of the first T1 electronics or second T1L electronics or third T1S electronics to a first and second interface of an electronics of the printed circuit board of the first device can be switched. Suitably, in this embodiment of the switching apparatus, a control unit for controlling the first and second switching unit can be provided on the printed circuit board of the first device, which control unit is connected to the first and second switching unit via a first and second control line, respectively.

The first and second switching units may suitably each be an analog switching unit, and the control unit may suitably be a controller.

By means of the aforementioned switching apparatus controlled by the controller, a socket part connected to the second switching unit and arranged on a printed circuit board of the first device, which socket part has a second interface for a plug connection with a plug part connected to a two-core single pair Ethernet cable, can advantageously be operated particularly reliably, efficiently and flexibly as a switchable 100Base T1, 10Base T1L or 10Base T1S interface.

The first and second switching units and the first T1, second T1L and third T1S electronics can be suitably arranged here together with the controller and the socket part on the printed circuit board of the first device, wherein the printed circuit board can advantageously be equipped with corresponding suitable components for providing the first and second switching units and the first T1, second T1L and third T1S electronics.

The first T1, second T1L, and third T1S electronics of the aforementioned switching apparatus may additionally be provided on first, second, and third printed circuit boards, respectively, which may be suitably arranged in a printed circuit board stack that can be plugged into a suitable printed circuit board slot of the first device.

The first and second switching units of the switching apparatus may each be arranged here on the printed circuit board of the first device, or each may be provided by means of a first and second switching element arranged together with the first T1, second T1L and third T1S electronics on the first, second and third printed circuit boards, respectively.

The first and second switching units and the first T1, second T1L and third T1S electronics can be integrated in a chip in a particularly advantageously compact and functional way, wherein the printed circuit board of the first device can be equipped with the chip in a suitable way.

In particular, a protruding switching apparatus comprising a first T1, second T1L and third T1S electronics and a first and second switching unit can advantageously be switched automatically with hardware and software support, and/or can have a hardware- and/or software-supported user interface for manual switching of the switching apparatus.

The switching apparatus of a first device can advantageously be switched automatically with hardware and software support, and a plug connection of a plug part, connected to a second device, to the socket part of the switching apparatus can be detected and checked by means of switching of the first and second switching unit for operation of the first T1 and second T1L and third T1S electronics by means of detection of data links. Upon detection of corresponding data links, the operation of the T1, T1L or T1S electronics at which the data links are detected can be switched, moreover as suitable for further compatible operation of the switching apparatus.

The switching apparatus may additionally comprise a suitable manual switch or pushbutton and/or a hardware- and software-supported user interface for manual switching of the switching apparatus, which may in particular be a web interface.

A switching apparatus described above according to one embodiment of the invention can advantageously be suitably designed and set up by means of the switching apparatus and in particular by means of the second interface for the provision of power over data line (PoDL).

The first device, on the printed circuit board of which a switching apparatus described above is provided, can be any device and in particular advantageously an SPE/T1 Ethernet switch described below or an SPE/T1 development board described below.

The second device connectable to a second interface of the switching apparatus may be, similarly to the first device, any apparatus or device having at least a first T1 or a second T1L or a third T1S electronics and a first and a second interface, which is suitable for data communication with at least one further second device via an SPE/T1 Ethernet switch.

Accordingly, the invention additionally relates to an SPE/T1 Ethernet switch which, according to one embodiment of the invention, may suitably comprise a first, second and third switching apparatus described above with a first T1, second T1L and third T1S electronics respectively, which may advantageously be arranged adjacent to one another in a triplet. The first T1, second T1L and third T1S electronics of the triplet can each be connected to a first, second and third socket part, which can in particular have a second interface.

In this way, a first, second and third port of the Ethernet switch can be provided by means of the first, second and third socket parts, which ports are each suitable for providing a data connection of second devices. The second devices can each be connected to the same first, second or third port of a preceding triplet for data transmission via the switch by means of a plug part also having a second interface.

In another particularly advantageous SPE/T1 Ethernet switch, a plurality n2 of switching apparatuses having a first T1, second T1L and third T1S electronics and a first and second switching unit can each be arranged adjacent to one another. Suitably, the second switching units can each be connected to a second interface of a suitable socket part, so that switchable ports are provided by means of the socket parts, the switching apparatuses and by means of a controller provided on a printed circuit board of the Ethernet switch. The switchable ports of the Ethernet switch are particularly advantageous, since, as described above, second devices connected to any ports can also be switched automatically into a 100Base T1, 10Base T1L or 10Base T1S SPE/T1 Ethernet data connection by means of the switching apparatus.

The second devices may be any SPE/T1 Ethernet apparatus or a device which in each case may have a suitable plug part with a second interface for a plug connection to a switchable port described above, and which may be connected to a two-wire SPE/T1 Ethernet cable.

As stated above, the first device with the printed circuit board on which a switching apparatus described above is arranged can advantageously be an SPE/T1 development board, which can be suitably designed to be Arduino(r)-compatible. The SPE/T1 development board can have its printed circuit board, a controller, a switching apparatus and a socket part which has a second interface and is provided for a plug connection to a plug part connected to a two-core single pair Ethernet cable.

By means of the SPE/T1 development board provided with a protruding switching apparatus, the first T1, second T1L and third T1S electronics are integrated into the Arduino(r) platform in their Arduino(r) compatible design and thus a simple entry into the SPE/T1 Ethernet technology is enabled. Furthermore, the SPE/T1 development board can be advantageously supplied with power via PoDL in this way.

Through the Arduino(r) platform, a user has a large pool of libraries and source code to fall back on for the development of applications. In addition, many different plug-on boards with sensors and actuators are available that can be used directly with the Arduino(r)-compatible SPE/T1 development board. Thus, the development of prototypes and demonstrators with SPE/T1 technology can be implemented much faster.

### EXEMPLARY EMBODIMENT

Exemplary embodiments of the invention are shown in the drawings and are explained in greater detail below. In the drawings:

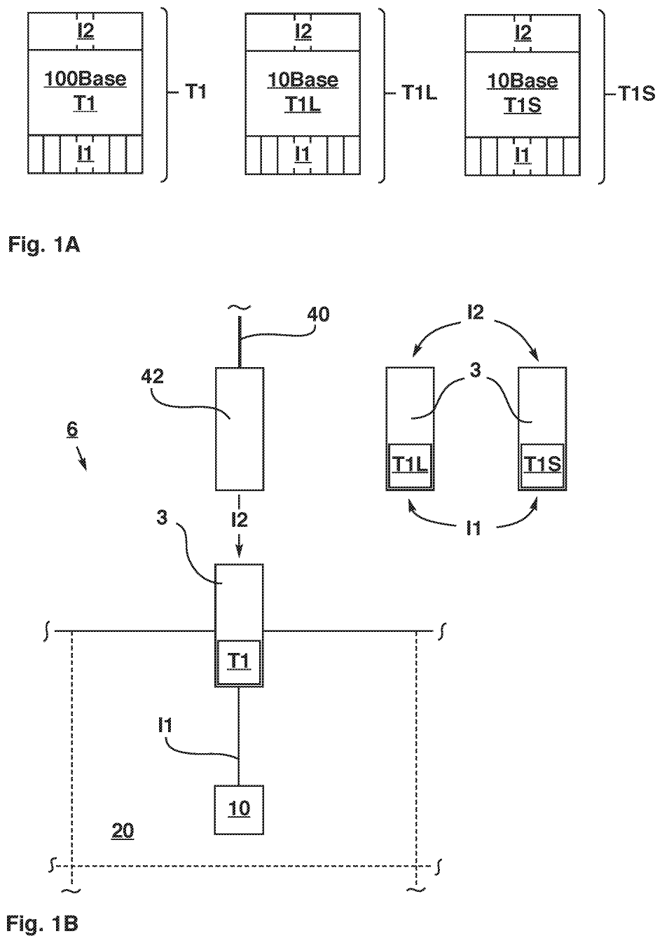

FIG. 1A shows first, second and third electronics of a switching apparatus according to one embodiment of the invention;

FIG. 1B shows a switching apparatus according to one embodiment of the invention;

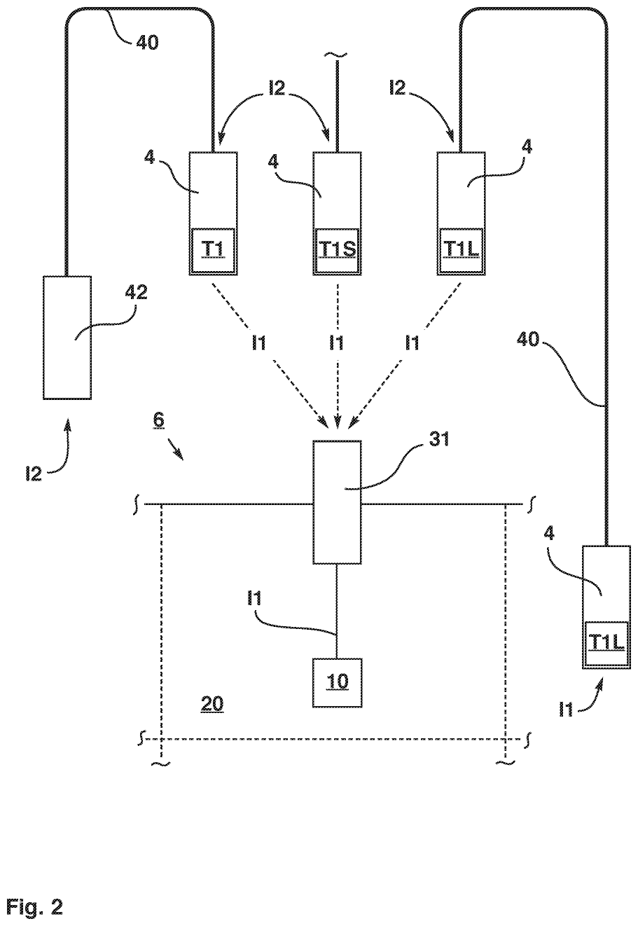

FIG. 2 shows a further switching apparatus according to one embodiment of the invention;

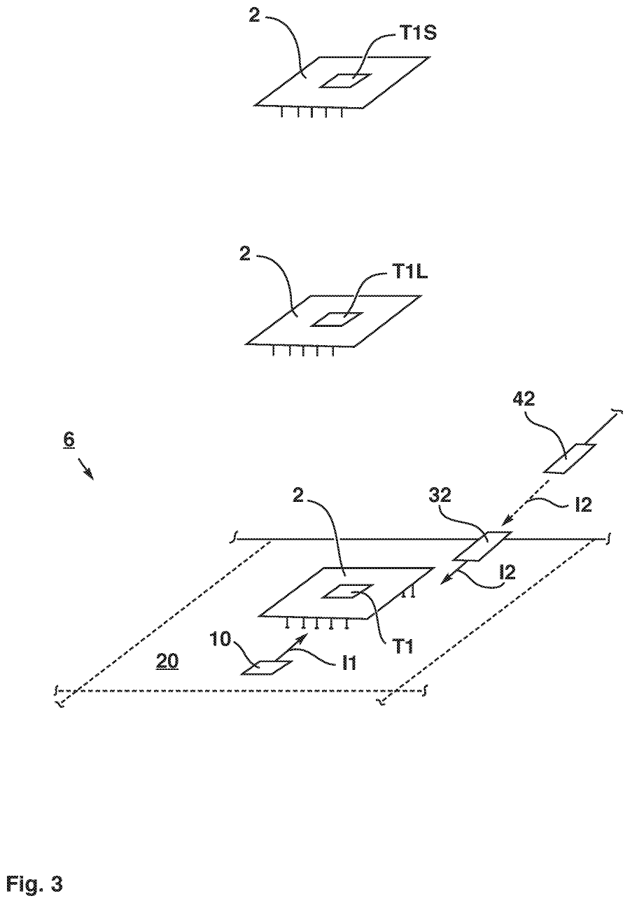

FIG. 3 shows a further switching apparatus according to one embodiment of the invention;

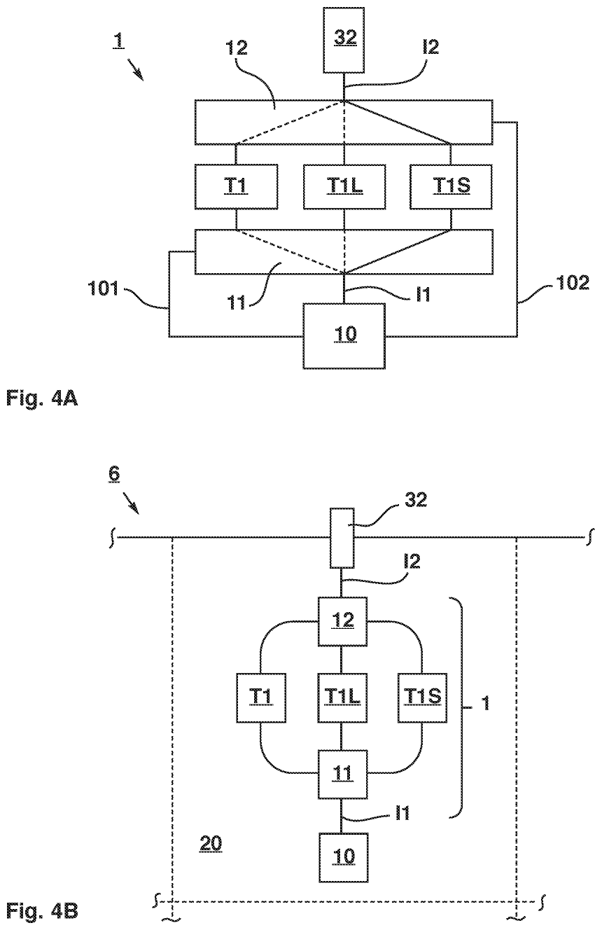

FIG. 4A shows a further switching apparatus according to one embodiment of the invention;

FIG. 4B shows the switching apparatus of FIG. 4A on a printed circuit board;

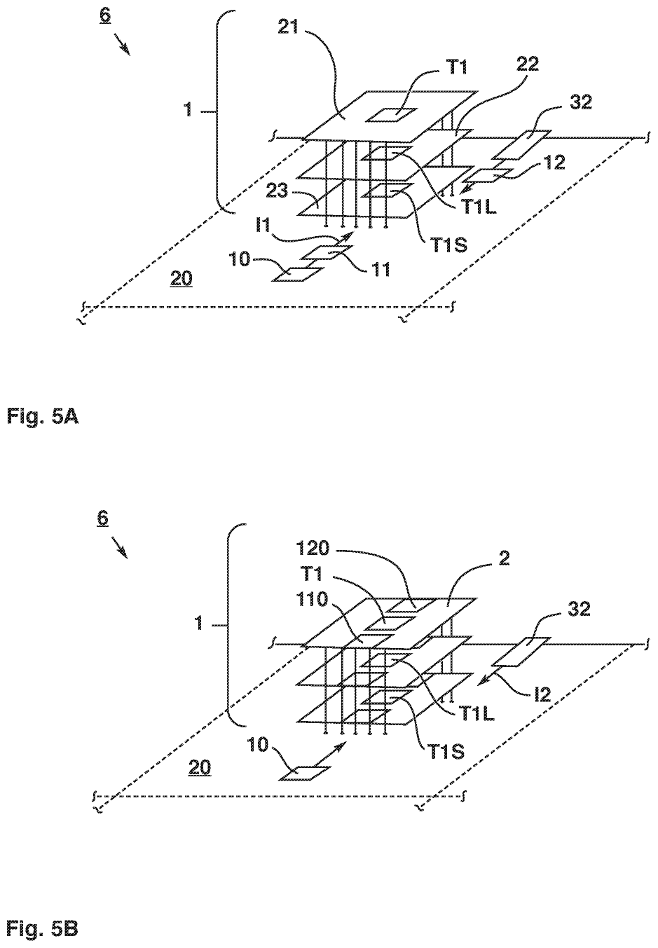

FIGS. 5A and B in each case show a further switching apparatus according to one embodiment of the invention;

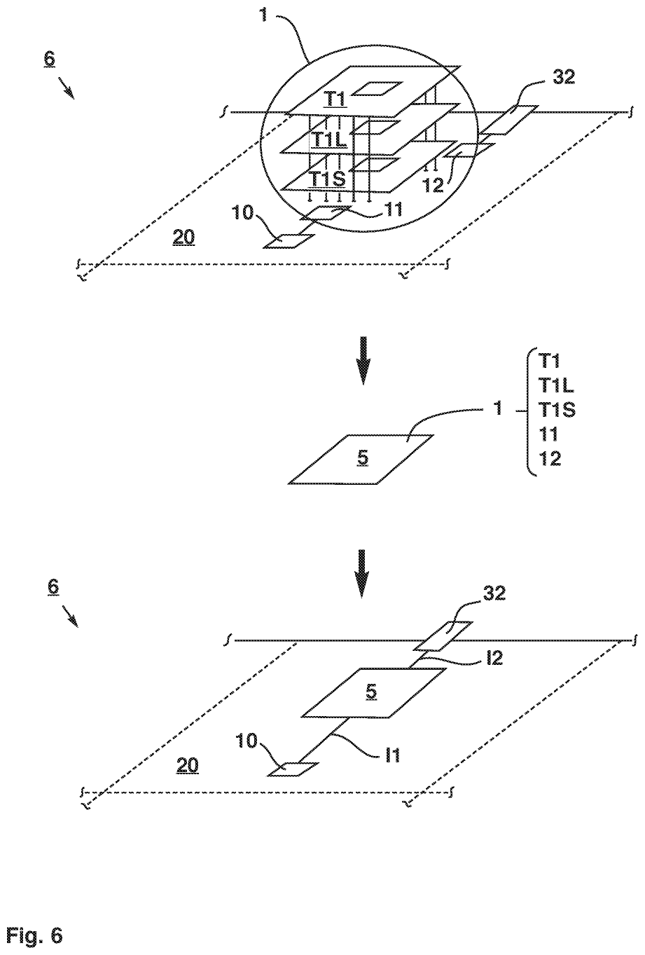

FIG. 6 shows a further switching apparatus according to one embodiment of the invention;

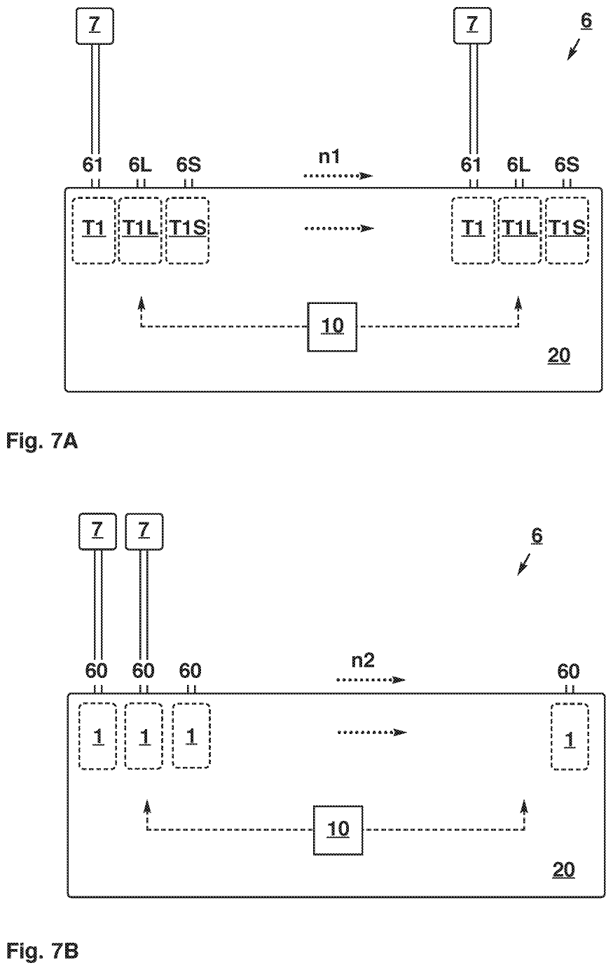

FIGS. 7A and B in each case show an Ethernet switch according to one embodiment of the invention; and

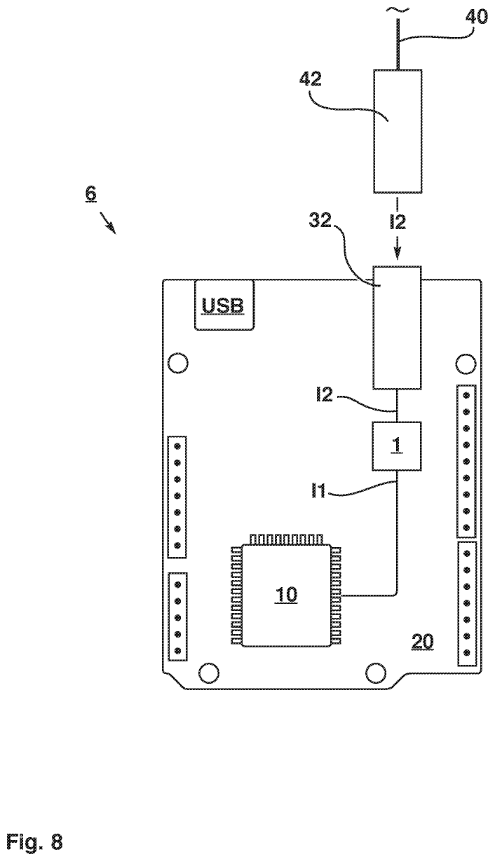

FIG. 8 shows an SPE/T1 development board according to one embodiment of the invention.

The figures contain partially simplified, schematic representations. In part, identical reference signs are used for like, but possibly not identical elements, which may not be shown in all figures. Different views of like elements could be scaled differently.

FIG. 1A shows first T1, second T1L and third T1S electronics of a switching apparatus according to one embodiment of the invention. The first electronics T1 has a switching apparatus with 100Base T1 electronics and first I1 and second I2 interfaces. The 100Base T1 electronics is a 100Base T1 Ethernet PHY-IC with further passive components. The first electronics T1 is suitably designed and set up in such a way that data transmission can be switched from the first interface I1 to the second interface I2 and from the second interface I2 to the first interface I1.

By means of the above first electronics T1, data transmission is made possible at a maximum range of 15 m (shielded 40 m) at a speed of 100 MBit/s to 1 GBit/s via single pair copper cables with twisted pairs. The first interface I1 is a multi-pole Ethernet interface and in particular an MII or RMII interface, and the second interface I2 is a two-pole SPE/T1 Ethernet interface I2.

The second electronics T1L has a switching apparatus with 10Base T1L electronics and a first I1 and second I2 interface. The 10Base T1L electronics is a 10Base T1L Ethernet PHY-IC with further passive components. The second electronics T1L is, similarly to the aforementioned first electronics T1, suitably designed and set up in such a way that a data transmission from the first interface I1 to the second interface I2 and from the second interface I2 to the first interface I1 can be switched.

By means of the aforementioned second electronics T1L, data transmission at a speed of 10 Mbit/s is made possible at a maximum range of 1000 m to shielded 1700 m via single pair copper cables with twisted pairs. Similarly to the first electronics T1, the first interface I1 is a multi-pole Ethernet interface and in particular an MII or RMII interface, and the second interface I2 is a two-pole SPE/T1 Ethernet interface I2.

The third electronics T1S has a switching apparatus with a 10Base T1S electronics and a first I1 and second I2 interface. The 10Base T1S electronics is a 10Base T1S Ethernet PHY-IC with further passive components, wherein the third electronics T1S, like the above first T1 and second T1L electronics, is suitably designed and set up in such a way that data transmission from the first interface I1 to the second interface I2 and from the second interface I2 to the first interface I1 can be switched.

By means of the aforementioned third electronics T1S, data transmission at a speed of 10 Mbit/s is made possible at a maximum range of 15 m in multi-drop operation with up to eight subscribers via single pair copper cables with twisted pairs. As with the first T1 and second T1L electronics, the first interface I1 is a multi-pole Ethernet interface and in particular an MII or RMII interface, and the second interface I2 is a two-pole SPE/T1 Ethernet interface I2.

By means of the above first T1, second T1L and third T1S electronics, a data transmission is switched between the first I1 and second I2 interfaces in each case, after which a switching apparatus is provided by means of the first T1, second T1L and third T1S electronics, respectively, according to one embodiment of the invention. The first T1, second T1L and third T1S electronics are advantageously designed here with their first I1 and second I2 interfaces in such a way that, in addition to an interface for data transmission, an interface for Power over Ethernet (POE) or Power over Dataline (PoD) interface is also provided via the first I1 and second I2 interfaces.

FIG. 1B shows a schematic representation of a switching apparatus according to one embodiment of the invention. The switching apparatus is provided by means of a socket part 3 of a plug connector having first T1 or second T1L or third T1S electronics described above with reference to FIG. 1A, in each case together with the first I1 and second I2 interfaces also described above.

A first aforementioned socket part 3 has first electronics T1 and is arranged with its first interface I1 on a printed circuit board 20 of a device 6 and is connected in this way to a first interface I1 of electronics 10 arranged on the printed circuit board 20. The socket part 3 is suitable with the second interface I2 of the first electronics T1 for a plug connection to a plug part 42, which is connected to a two-core single pair Ethernet cable 40.

It is clear that the socket part 3 arranged on the printed circuit board 20 can also have a second T1L or third T1S electronics instead of the first electronics T1. In the drawing, a corresponding socket part 3 having a second electronics T1L and a socket part 3 having a third electronics T1S are shown next to the printed circuit board 20 for this purpose.

The device 6 may be any device 6 and in particular an SPE/T1 Ethernet switch 6 described below with reference to FIG. 7A or an SPE/T1 development board 6 described below with reference to FIG. 8.

FIG. 2 shows a schematic representation of a further switching apparatus according to one embodiment of the invention. The switching apparatus is provided by means of a plug part 4 of a plug connector, which may have first T1 or second T1L or third T1S electronics described above with reference to FIG. 1A, in each case together with the first I1 and second I2 interfaces also described above.

The plug part 4 is provided with its first interface I1 in particular for a plug connection to a socket part 31, also having a first interface I1, of a printed circuit board 20 of a device 6, and is connected by its second interface I2 to one end of a two-core single pair Ethernet cable 40. A plug part 42 likewise having a second interface I2 may be provided at another end of the cable 40. As an example, the plug part 4 with the first electronics T1 is connected to the plug part 42 via the cable 40 in the drawing.

Another plug part 4 having a first I1 and second I2 interface can also be connected to the other end of the cable 40. By way of example, in the drawing the plug part 4 with the second electronics T1L is connected via the cable 40 to the plug part 4 also having the second electronics T1L and a first I1 and second I2 interface. Of course, the plug part 4 having the second electronics T1L with its first interface I1 is also suitable for connection to the socket part 31, which also has a first interface I1 and is connected by its first interface I1 to an electronics 10 of the printed circuit board 20.

The further plug part 4 having third electronics T1S is also suitable with its first interface I1 for a connection to the socket part 31, wherein a plug part 42 or a further plug part 4 having third electronics T1S can be connected at the other end of its two-core single pair Ethernet cable 40, not shown in the drawing.

FIG. 3 shows a schematic representation of a switching apparatus according to one embodiment of the invention. The switching apparatus is provided by means of a printed circuit board 2, on which the first T1 or second T1L or third T1S electronics can be arranged.

The printed circuit board 2 is suitably designed here in such a way that it can be plugged into a slot of a printed circuit board 20 of a device 6, so that the first interface I1 is connected to a first interface I1 of electronics 10 of the printed circuit board 20, and the second interface I2 is connected to a second interface I2 of a socket part 32 of a plug connector arranged on the printed circuit board 20. The socket part 32 is thereby provided with its second interface I2 for a plug connection to a plug part 42 of the connector, which is connected to a two-core single pair Ethernet cable 40.

In the drawing, the printed circuit board 2 having the first electronics T1 is inserted as intended into the slot provided for it on the printed circuit board 20. It is clear that, by means of suitable selection of the printed circuit board 2 plugged onto the printed circuit board 20, the socket part 32 can be set up as 100Base T1, 10Base T1L or 10Base T1S interface I2.

FIG. 4A shows a schematic representation of a switching apparatus 1 according to one embodiment of the invention, and FIG. 4B shows the switching apparatus 1 of FIG. 4A on a printed circuit board 20 of a device 6.

The switching apparatus 1 advantageously has first T1, second T1L and third T1S electronics, a first I1 and second I2 interface, and a first 11 and second 12 switching unit. The first 11 and second 12 switching unit is suitably designed and set up here in such a way that, by means of the first 11 and second 12 switching unit, in each case a connection of the first T1 or second T1L or third T1S electronics to a first I1 or second I2 interface of electronics of a printed circuit board 20 of a device 6 can be switched.

A control unit 10 for controlling the first 11 and second 12 switching units is provided on the printed circuit board 20 for the above circuit, the control unit 10 being connected to the first 11 and second 12 switching units for this purpose via a first 101 and second 102 control line, respectively. The control unit 10 may suitably be a controller 10.

By means of the above switching apparatus 1 controlled by the controller 10, a socket part 32 connected to the second switching unit 12 and arranged on a printed circuit board 20 of a device 6 and having a second interface I2 for a plug connection with a plug part 42 connected to a two-core single pair Ethernet cable 40 can advantageously be operated as a 100Base T1, 10Base T1L or 10Base T1S interface I2.

According to the embodiment of FIG. 4B, the switching apparatus 1 may be arranged on the printed circuit board 20 together with the controller 10 and the socket part 32 with its first 11 and second 12 switching unit and its first T1, second T1L and third T1S electronics. The first 11 and second 12 switching units may suitably each be an analog switching unit. With respect to the first T1, second T1L and third T1S electronics and their first I1 and second I2 interfaces, reference is made here to their aforementioned description with reference to FIG. 1A. The printed circuit board 20 is suitably equipped with the corresponding aforementioned components of the switching apparatus 1 of the embodiment of FIG. 1A and FIGS. 4A and B.

FIG. 5A shows a schematic representation of a switching apparatus 1 according to one embodiment of the invention, and FIG. 5B shows a modification of the switching apparatus 1 from FIG. 5A.

The first T1, second T1L, and third T1S electronics of the switching apparatus 1 of FIGS. 5A and B are provided on first 21, second 22, and third 23 printed circuit boards, respectively, which are arranged in a printed circuit board stack at a predetermined slot of the printed circuit board 20.

In the embodiment of the switching apparatus 1 of FIG. 5A, the first 11 and second 12 switching units of the switching apparatus 1 are suitably arranged on the printed circuit board 20 together with the controller 10 and the socket part 32, respectively.

Unlike the embodiment of the switching apparatus 1 from FIG. 5A, in the embodiment of the switching apparatus 1 of FIG. 5B, the first 11 and second 12 switching units are provided, respectively, by means of first 110 and second 120 switching elements arranged together with the first T1, second T1L and third T1S electronics on the first 21, second 22 and third 23 printed circuit boards, respectively.

FIG. 6 shows a schematic representation of a switching apparatus 1 according to a further embodiment of the invention, in which the switching apparatus 1 with the first T1, second T1L and third T1S electronics and the first 11 and second 12 switching unit is formed as a chip 5. The printed circuit board 20 of a device 6 is suitably equipped with the controller 10, the first I1 and second I2 interfaces, the socket part 32, and with the chip 5.

The device 6 from FIGS. 2, 3, 4B, 5A, 5B and 6, similarly to the device 6 from FIG. 1B, may also be any device 6 and in particular an Ethernet switch 6 described below with reference to FIGS. 7A and B, or an SPE/T1 development board 6 described below with reference to FIG. 8.

FIGS. 7A and B each show a schematic diagram of an Ethernet switch 6 according to one embodiment of the invention.

In the SPE/T1 Ethernet switch 6 of the embodiment from FIG. 7A, a first T1, second T1L, and third T1S electronics of the switching apparatus from FIG. 1B or FIG. 3 are respectively arranged adjacently to each other in a triplet having corresponding ports 61, 6L, and 6S. The ports 61, 6L and 6S may each be provided by means of a corresponding socket part 3 or 32. The ports 61, 6L and 6S of the embodiment from FIG. 7A are each suitable only for providing a data connection of devices 7 connected to the same port 61, 6L or 6S of one of the above triplets. The switch 6 from FIG. 7A is designed for an exemplary multiplicity of n1 triplets having a corresponding number of n1 ports 61, 6L and 6S.

In the SPE/T1 Ethernet switch 6 of the embodiment of FIG. 7B, a plurality n2 of switching apparatuses 1 from FIG. 4B, FIG. 5A, FIG. 5B or FIG. 6 having first T1, second T1L and third T1S electronics are each arranged adjacently to each other and have ports 60 switchable by means of the controller 10 and the switching apparatus 1. The ports 60 are each provided here by means of a corresponding socket part 32. In contrast to the ports 61, 6L and 6S of the embodiment from FIG. 7A, in the embodiment from FIG. 7B devices 7 connected to any ports 60 can advantageously be brought into a 100Base T1, 10Base T1L or 10Base T1S SPE/T1 Ethernet data connection by means of the switching apparatus 1.

The Ethernet switch 6 of the embodiment from FIGS. 7A and B, in each case, is further set up such that the ports 61, 6L and 6S and the ports 60, respectively, can be suitably switched and managed by the controller 10. The devices 7 from FIGS. 7A and B may be any SPE/T1 Ethernet apparatus or device 7 that may have a suitable plug part 42 for plug connection to a port 61, 6L and 6S or to a port 60, respectively, and that may be connected to a two-core SPE/T1 Ethernet cable 40.

FIG. 8 shows a schematic diagram of an SPE/T1 development board 6 according to one embodiment of the invention, comprising the printed circuit board 20, the controller 10, the switching apparatus 1 and the socket part 32, which is provided for a plug connection to a plug part 42 connected to a two-core single pair Ethernet cable 40. In particular, the development board 6 may be an Arduino(r)-compatible development board 6, by means of which the first T1, second T1L, and third T1S electronics are integrated into the Arduino(r) platform, thereby enabling easy entry into SPE/T1 Ethernet technology. Furthermore, the Arduino(r)-compatible development board 6 can be powered via PoDL, as described above with reference to FIG. 1A.

By means of a SPE/T1 development board 6, in particular designed as an Arduino(r)-compatible development board 6, a user has a large pool of libraries and source code to fall back on for the development of an application. In addition, many different plug-on boards with sensors and actuators are available that can be used directly with the Arduino(r)-compatible SPE/T1 development board 6. Thus, the development of prototypes and demonstrators with SPE/T1 technology can be implemented much faster.

The SPE/T1 development board 6 is suitable in particular as development board 6 for the creation of prototypes and demonstrators where a SPE/T1 Ethernet connection is required. The SPE/T1 development board 6 is particularly suitable for developers for the creation of SPE/T1 Ethernet applications.

In particular, the above switching apparatus 1 of a device 6 can advantageously be switched automatically with hardware and software support, wherein a plug connection of a plug part 42 to a socket part 32 can be detected and checked for operation of the first T1 and second T1L and third T1S electronics and for detection of data links by means of a switching of the first 11 and second 12 switching unit. Upon detection of corresponding data links, the operation of the electronics T1, T1L or T1S at which data links are detected can be switched as suitable for further operation.

It is clear that the switching apparatus 1 may further comprise a suitable manual switch or pushbutton and/or a hardware and software-based user interface for manual switching of the switching apparatus 1, which may in particular be a web interface.

Even though various aspects or features of the invention are each shown in combination in the figures, it is apparent to the person skilled in the art—unless otherwise indicated—that the combinations shown and discussed are not the only possible ones. In particular, corresponding units or feature complexes from different exemplary embodiments may be interchanged.

### LIST OF REFERENCE SIGNS

1 switching apparatus
10 electronics, control unit, controller (controller)
101, 102 first, second control line
11, 12 first, second switching unit
110, 120 first, second switching element
2, 20 printed circuit board
21, 22, 23 first, second, third printed circuit board
3, 31, 32 plug connector, socket part
4, 42 plug connector, plug part
40 cable
5 chip
6 device, Ethernet switch, development board
60, 61, 6L, 6S port
7 apparatus, device
I1, I2 first, second interface
n1, n2 number
T1, TI1, T1S first, second, third electronics

1. A switching apparatus for providing a single pair Ethernet (SPE/T1-Ethernet) connection, having
a first and second interface, wherein
the first interface is a multi-pole and in particular an MII or RMII interface, and the second interface is a two-pole SPE/T1-specific interface, and wherein
the switching apparatus additionally
has first electronics suitable for 100Base-T1 operation and/or second electronics suitable for 10Base-T1L operation and/or third electronics suitable for 10Base-T1S operation of the second interface.

2. The switching apparatus as claimed in claim 1, wherein the switching apparatus
has at least one printed circuit board with the first or second or third electronics, wherein
the printed circuit board is configured to be plugged into a slot of a printed circuit board of a device in such a way that
the first interface is connected is configured for connection to electronics of the printed circuit board, and
the second interface is configured for connection to a socket part of a plug connector which is provided for a plug connection to a plug part of the connector which is connected to a two-core single pair Ethernet cable.

3. The switching apparatus as claimed in claim 1, wherein the switching apparatus
has at least one plug connector
with the first or second or third electronics and with the first and second interface,
wherein
the plug connector is a socket part, which
configured for connection by its first interface to a printed circuit board of a device, and
is provided with its second interface configured for a plug connection to a plug part which is connected to a two-core single pair Ethernet cable, or
the plug connector is a plug part, which
is provided with its first interface configured for a plug connection to a socket part of a printed circuit board of a device, and
is connected by its second interface to a two-core single pair Ethernet cable.

4. The switching apparatus as claimed in claim 1, wherein
the switching apparatus is a switching apparatus that has first, second and third electronics and a first and second switching unit, wherein the first and second switching units are configured such a way that in each case a connection of the first or second or third electronics to a first and second interface of electronics of a printed circuit board of a device can be switched, and wherein
a control unit configured for controlling the first and second switching units is provided on the printed circuit board and is connected to the first and second switching units via first and second control lines, respectively.

5. The switching apparatus as claimed in claim 4, wherein
the first and second switching units, and
the first, second and third electronics are arranged on the printed circuit board of the device.

6. The switching apparatus as claimed in claim 4, wherein
the first, second and third electronics are each provided on a first, second and third printed circuit board arranged in a printed circuit board stack on the printed circuit board, wherein
the first and second switching units are each arranged on the printed circuit board of the device, or
are provided by means of first and second switching elements, respectively, which are arranged together with the first, second and third electronics on the first, second and third printed circuit boards, respectively.

7. The switching apparatus as claimed in claim 4, wherein
the first and second switching units and the first, second and third electronics are integrated in a chip.

8. The switching apparatus as claimed in claim 4, wherein
the switching apparatus configured for automatic switching with hardware and software support, and/or
the switching apparatus has a hardware- and/or software-supported user interface configured for manual switching of the switching apparatus.

9. The switching apparatus as claimed in claim 1, wherein
Power over Data Line (PoDL) is provided by the switching apparatus.

10. A switch having a switching apparatus as claimed in claim 1 configured for providing an SPE/T1 Ethernet connection of at least two devices, wherein
the switch has a multiplicity of first, second and third terminals, or
has a multiplicity of switchable ports, each of which is provided by a second interface of the switching apparatus.

11. The switch as claimed in claim 10, wherein
the switch with the switchable ports configured that devices connected to any ports by the switching apparatus can also be automatically switched into a 100Base T1, 10Base T1L or 10Base TIS SPE/T1 Ethernet data connection.

12. An SPE/T1-development board comprising a switching apparatus as claimed in claim 1.

13. The switching apparatus as claimed in claim 4, wherein Power over Data Line (PoDL) is provided by the switching apparatus.

14. A switch having a switching apparatus as claimed in claim 9 configured for providing an SPE/T1 Ethernet connection of at least two devices, wherein
the switch has a multiplicity of first, second and third terminals, or
has a multiplicity of switchable ports, each of which is provided by means of a second interface of the switching apparatus.

15. The switch as claimed in claim 14, wherein
the switch with the switchable ports configured that devices connected to any ports by the switching apparatus can also be automatically switched into a 100Base T1, 10Base T1L or 10Base T1S SPE/T1 Ethernet data connection.

16. An SPE/T1-development board comprising a switching apparatus as claimed in claim 4.

17. An SPE/T1-development board comprising a switching apparatus as claimed in claim 9.
